(19) United States
(12) Patent Application Publication
(10) Pub. No.: US 2013/0111379 A1
(43) Pub. Date: May 2, 2013

(54) COMPUTING DEVICE AND CONTROL METHOD THEREOF

(71) Applicants: Sang-jin HONG, Seoul (KR); Su-yong KIM, Yongin-si (KR); Kyung-do PARK, Suwon-si (KR); Mi-ra EOM, Suwon-si (KR); Jong-hwa LEE, Suwon-si (KR); Ji-won IM, Hwaseong-si (KR)

(72) Inventors: Sang-jin HONG, Seoul (KR); Su-yong KIM, Yongin-si (KR); Kyung-do PARK, Suwon-si (KR); Mi-ra EOM, Suwon-si (KR); Jong-hwa LEE, Suwon-si (KR); Ji-won IM, Hwaseong-si (KR)

(73) Assignee: SAMSUNG ELECTRONICS CO., LTD., Suwon-si (KR)

(21) Appl. No.: 13/651,523

(22) Filed: Oct. 15, 2012

(30) Foreign Application Priority Data
Oct. 26, 2011 (KR) 10-2011-0109814

(51) Int. Cl. G06F 3/048

(52) U.S. Cl. 715/764

(57) ABSTRACT

A computing device includes a display unit to display a screen, a touch input unit to receive a user's touch input on the display unit, and a controller to display a locking image on the screen with a predetermined degree of definition while the computing device is locked, to decrease the degree of definition of the locking image if the user's touch input is determined to be an unlocking input, and to unlock the computing device if the unlocking input meets an unlocking condition.

### CROSS-REFERENCE TO RELATED APPLICATIONS

This application claims the benefit of priority under 35 U.S.C.§119 from Korean Patent Application No. 10-2011-0109814 filed Oct. 26, 2011 with the Korean Intellectual Property Office on Aug. 22, 2002, the disclosure of which is incorporated herein by reference in its entirety.

### BACKGROUND

1. Field

Apparatuses and methods consistent with the exemplary embodiments relate to a computing device and a control method thereof, and more particularly, to a computing device and a control method thereof to control a screen according to a user's touch input.

2. Description of the Related Art

In recent years, a computing device, such as tablet PCs, smart phones and smart pads, has been widely used. Such a computing device has a touch panel to display a screen.

The computing device is in a locking state to be used in a permitted circumstance. For example, the computing device is locked when it is turned on initially, or to prevent a malfunction by an unintentional touch unless the computing device is in use or allows an authorized user to use. The touch-based computing device may require a user unlocking method to unlock the computing device.

### SUMMARY

The present general inventive concept provides a computing device and a control method thereof to enable a user to unlock the computing device more intuitively.

Additional aspects and advantages of the present general inventive concept will be set forth in part in the description which follows and, in part, will be obvious from the description, or may be learned by practice of the general inventive concept.

The foregoing and/or other features and utilities of the present general inventive concept may be achieved by providing a computing device including a display unit to display a screen, a touch input unit to receive a user's touch input on the display unit, and a controller to display a locking image on the screen with a predetermined degree of definition while the computing device is locked, to decrease the degree of definition of the locking image if the user's touch input is determined to be an unlocking input, and unlocks the computing device if the unlocking input meets an unlocking condition.

The controller may decrease the degree of definition of the locking image corresponding to at least one of a movement distance, a movement speed and a touch time of the unlocking input.

The controller may display a background image with a lower degree of definition than the locking image below the locking image while the computing device is locked, and increase the degree of definition of the background image if the user's touch input is determined to be the unlocking input.

The controller may increase the degree of definition of the background image corresponding to at least one of a movement distance, a movement speed and touch time of the unlocking input.

The controller may display an unlocking image on the screen corresponding to the unlocking input.

The foregoing and/or other features and utilities of the present general inventive concept may also be achieved by providing a control method of a computing device, the control method including displaying a locking image with a predetermined degree of definition on a screen of a display unit while the computing device is locked, receiving a user's touch input on the display unit, decreasing the degree of definition of the locking image if the user's touch input is determined to be the unlocking input; and unlocking the computing device if the unlocking input meets an unlocking condition.

The decreasing of the degree of definition may include decreasing the degree of definition of the locking image corresponding to at least one of a movement distance, a movement speed and touch time of the unlocking input.

The control method may further include displaying a background image with a lower degree of definition than the locking image below the locking image when the computing device is locked; and increasing the degree of definition of the background image if the user's touch input is determined to be the unlocking input.

The increasing of the degree of definition may include increasing the degree of definition of the background image corresponding to at least one of a movement distance, a movement speed and touch time of the unlocking input.

The control method may further include displaying an unlocking image on the screen corresponding to the unlocking input.

The foregoing and/or other features and utilities of the present general inventive concept may also be achieved by providing a computer-readable medium to contain computer-readable codes as a program to execute a control method of a computing device, the control method including displaying a locking image with a predetermined degree of definition on a screen of a display unit when the computing device is locked, receiving a user's touch input on the display unit, decreasing the degree of definition of the locking image when the user's touch input is determined to be the unlocking input, and unlocking the computing device when the unlocking input meets an unlocking condition.

The foregoing and/or other features and utilities of the present general inventive concept may also be achieved by providing a computing device including a display unit having a screen with a locking image in a locking state, an input unit to receive a user input through the display unit, and a controller to control a characteristic of the locking image according to the user input to correspond to an unlocking condition until the locking state is changed to an unlocking state.

The characteristic of the locking image may include a definition of the locking image.

The user input may include a plurality of points disposed in the screen.

The user input may include a line connecting a first point to a second point within the screen.

The user input may include a line disposed within the screen.

The user input may include at least one disconnected portion.

The controller may control the characteristic of the locking image before the computer device is changed from the locking state to the unlocking state.

The controller may control the characteristic of the locking image according to an identical ratio between the user input and the unlocking condition.

The characteristic of the locking image may include a definition of the locking image, and the controller controls the definition of the locking image according to a characteristic of the user input.

The characteristic of the locking image may include a definition of the locking image, the definition of the locking image may include a plurality of sub-definitions, and the controller may control the display unit to change the definition of the locking image between the sub-definitions.

The locking image may include a plurality of images displayed in the screen in a locking state, and the controller may control characteristics of the images according to the user input.

The controller may include at least a portion of the user input to the unlocking condition, and the controller may change the characteristic of the locking image according to the comparison result until an entire portion of the user input corresponds to the unlocking condition.

The controller may start a comparison operation when at least a portion of the user input is input through the display unit, and may control the characteristic of the locking image until the portion of the user input is increased to an entire portion of the user input corresponding to the unlocking condition.

The controller may control the display unit to display a change of the characteristic of the locking image when a portion of the user input correspond to a portion of the unlocking condition, and the controller may stop a change of the characteristic of the locking image when at least a portion of the user input does not correspond to the unlocking condition.

The controller may perform a user change from a first user to a second user according to the user input corresponding to the unlocking condition.

The display unit may display the locking image within a limited portion of the screen, and receives the user input within an unlimited portion of the screen in the locking state.

The display unit may receive the user input without an additional image displayed on the screen to correspond to the user input.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a computing device according to an exemplary embodiment of the present general inventive concept;

FIG. 2 is a block diagram illustrating the computing device of FIG. 1;

FIG. 3 is a flowchart illustrating a control method of a computing device according to an exemplary embodiment of the present general inventive concept;

FIGS. 4 and 5 illustrate an example of a screen with UI items in the computing device of FIG. 1s;

FIG. 6 illustrates a flowchart illustrating a control method of a computing device of FIG. 1; and

FIGS. 7A-7F illustrates unlocking condition input windows of a computing device of FIG. 1.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

Hereinafter, a computing device and a control method according to an exemplary embodiment of the present general inventive concept will be described in detail.

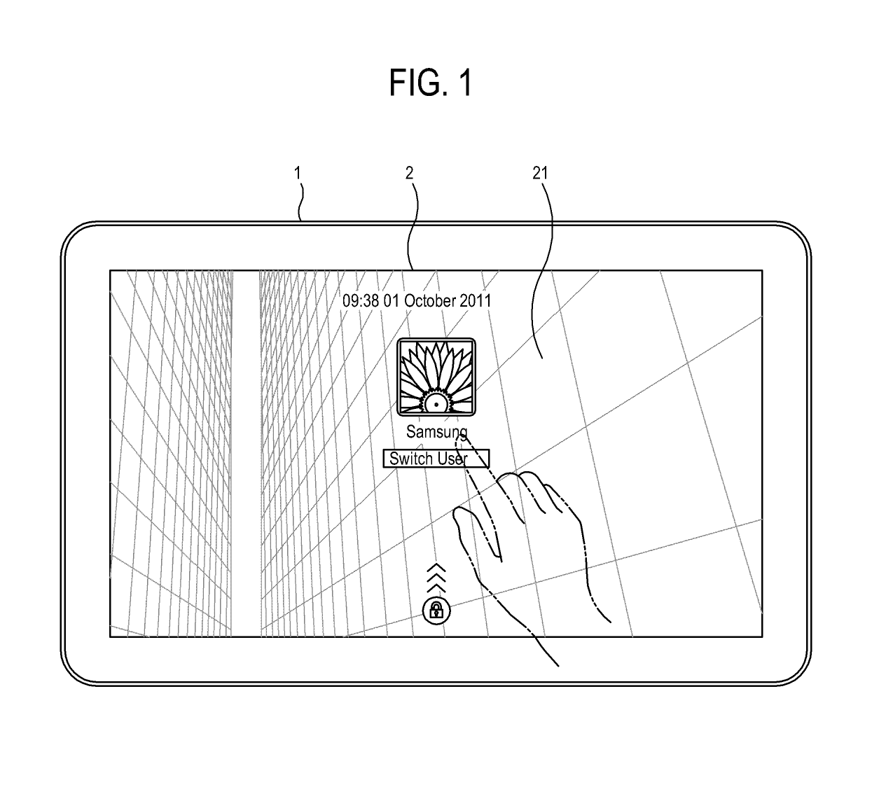

FIG. 1 illustrates a computing device according to an exemplary embodiment of the present general inventive concept. The computing device 1 may include a mobile computer apparatus, a tablet PC, a smart phone or a smart pad. The computing device 1 may have a housing frame, a display formed on the housing frame to display an image, and electrical and mechanical components disposed in the housing frame to control the display and to perform functions thereof. The computing device 1 has a display unit formed with a screen 2 to display an image according to a function of the computing device 1. The screen of the display unit of the computing device 1 may display an image according to a user input, for example, a user's touch input. The computing device 1 may have a plurality of modes, for example, a locking mode (locking mode), an unlocking state (unlocking mode), a user switching mode, etc., according to a user input to the computing device 1 or a function of the computing device 1. The computing device 1 may be locked in a mode to be used only in predetermined circumstances. For example, the computing device 1 is locked when the computing device 1 is turned on or is locked to prevent a malfunction by an unintentional touch unless the computing device 1 is in use or allows an authorized user only to use the computing device 1.

If a user's touch input does not meet a predetermined unlocking condition, the touch input is ignored and the computing device 1 remains locked. The computing device 1 is unlocked if the user's touch input meets the unlocking condition. Once unlocked, a user may use functions of the computing device 1 according to a user input, for example, a touch input.

The computing device 1 displays a locking image 21 to inform a user of a current locking state. The locking image 21 may be clearly displayed with a predetermined degree of definition (or resolution). If a user's touch input is determined to be an unlocking input, the computing device 1 decreases the degree of definition of the locking image. That is, if the unlocking input is continuously received, the locking image is gradually blurred. The definition of the locking image may be changed from a first definition to a second definition. It is possible that the definition may be gradually changed from a first definition to a second definition. It is possible that the definition may be linearly decreased in a unit of a predetermined level. Accordingly, a user may intuitively know that a user input unlocks the computing device 1, and this improves user's convenience. The computing device 1 is unlocked if the user's unlocking input meets the unlocking condition.

The computing device 1 may include a switch user window to allow a change of a user. A user may select (touch) the switch user window and then input a password or the user's touch input such that a user of the computing device 1 is changed from a first user to a second user. When the computing device 1 may determine whether the password or the user's touch input is identical to an unlocking condition corresponding to the user, the computing device 1 may be changed from the locking state to the unlocking state and/or from a first user mode to a second user mode.

It is possible that the computing device 1 may receive the user's touch input as described above and/or a password through a password input window such that to change the locking state to the unlocking state. The computing device 1 may determine whether the user's touch input is identical to the unlocking condition or whether the password is identical to a reference password as the unlocking condition, according to a user input, for example, the user's touch input and/or the password, so that the computing device 1 changes the locking state to the unlocking state.

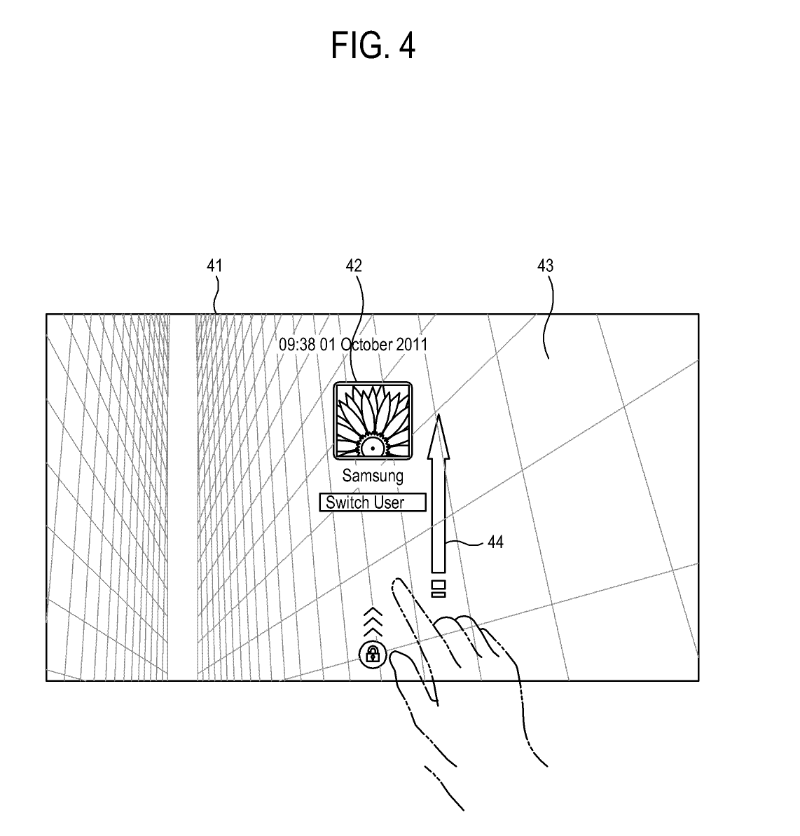

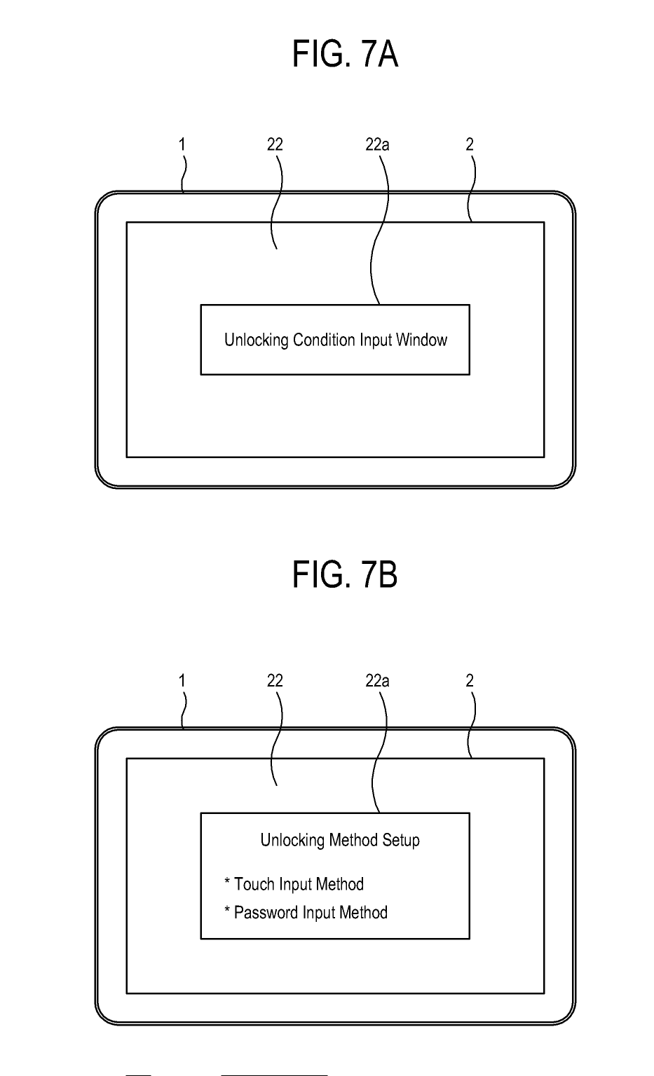

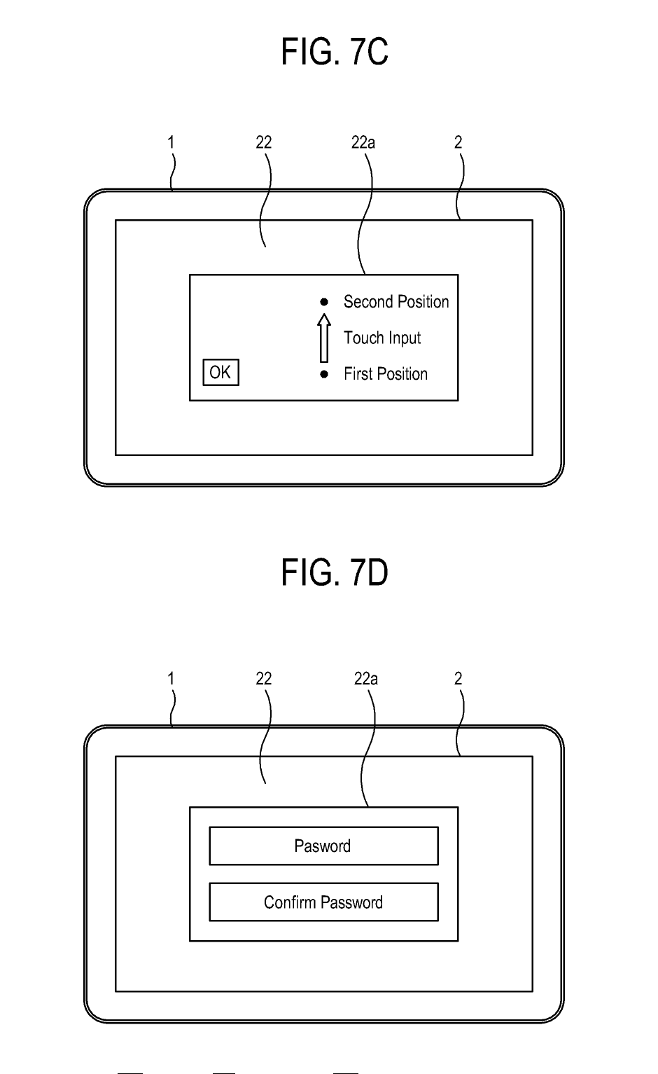

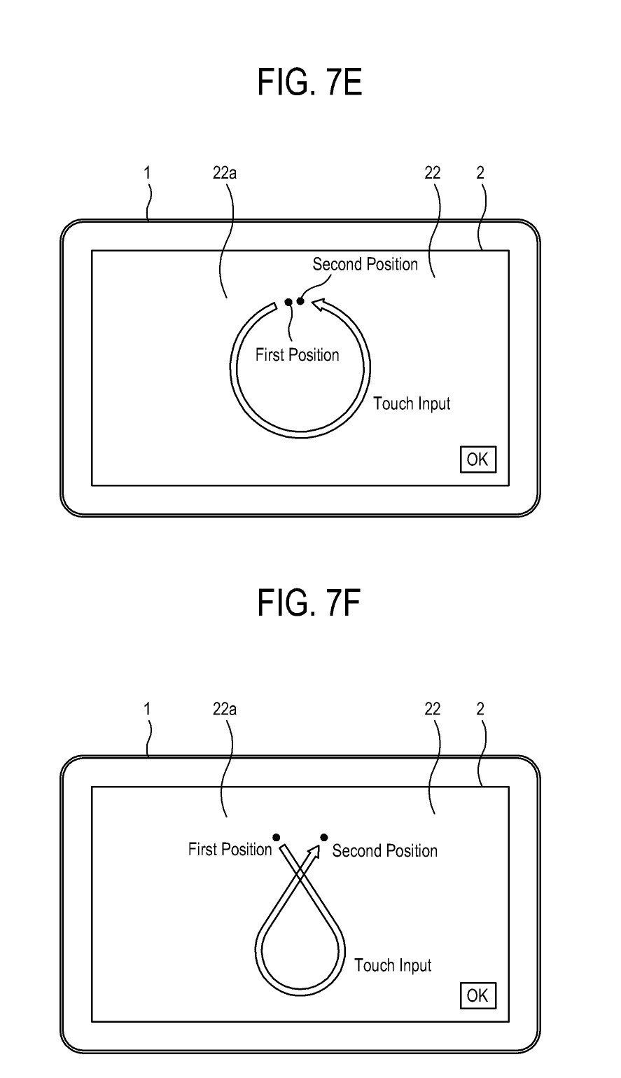

It is possible that the computing device 1 may display an unlocking condition input window 22a in an unblocking state screen 22 as illustrated in FIGS. 7A such that a user can set up an unlocking method as the unlocking condition to correspond to a user's touch input method and a password input method through the unlocking condition input window 22a as illustrated in FIG. 7B. The unlocking condition input window 22a may have a size or area which is the same as the screen 22 or smaller than that of the screen 22. The touch input method is illustrated in FIG. 7C to show a first position (starting position), a second position (ending position), and the touch input connecting the first position to the second position as the touch input set up. The above-described touch input set up is stored in a memory of the computing device 1, for example, a nonvolatile memory of the computing device 1 such that the stored touch input can be compared to a user touch input of the locking state screen 21. The password input method is illustrated in FIG. 4D. Once either the touch input or the password input is done, a user may select a button or icon OK to further process the setup. It is possible that both the touch input method and the password input method can be set up in the unlocking condition input window 22a and stored in the memory. It is also possible that the touch input method can be set up and stored in the memory without setting up the password input method according to a user preference. It is also possible that the touch input can be used in a predetermined mode of the computing device 1 and that the password input can be used in a turn off and then on mode of the computing device 1.

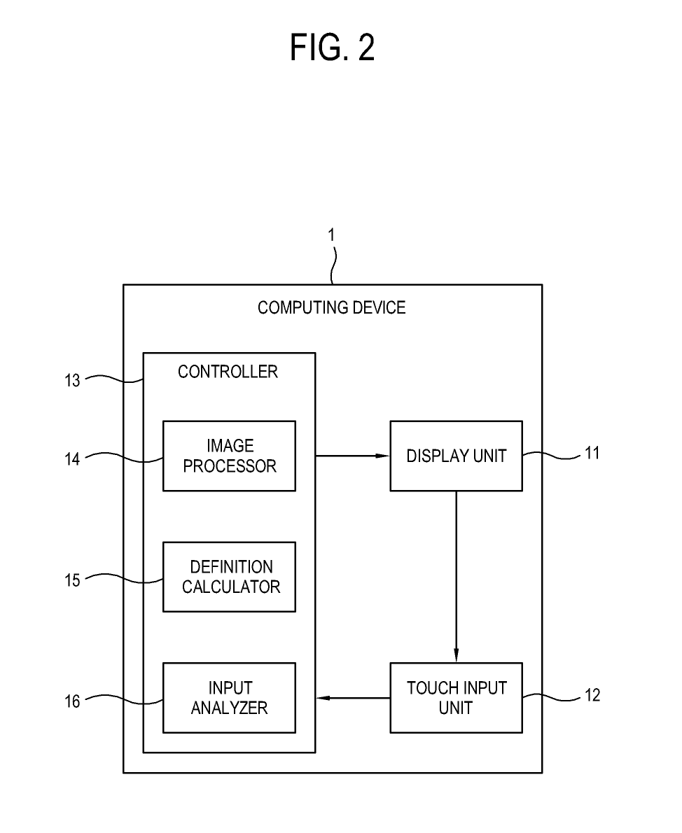

FIG. 2 is a block diagram illustrating the computing device 1 of FIG. 1. Referring to FIGS. 1 and 2, the computing device 1 includes a display unit 11, a touch input unit 12 and a controller 13. The display unit 11 displays the locking image 21 on the screen 2. The touch input unit 12 receives a user's touch input on the screen 2 of the display unit 11. If it is determined that the user's touch input is an unlocking input when the computing device 1 is locked, the controller 13 decreases the degree of definition of the locking image 21. The controller 13 unlocks the computing device 1 if the user's unlocking input continues to meet the unlocking condition.

When the user inputs a portion of the user's touch input, the definition of the locking image 21 is changed to a level corresponding to a ratio of the portion and an entire portion of the user's touch input. The level of the definition of the locking image 21 may be continuously or gradually changed according to the increased portion of the user's touch input.

An initial portion of the user's touch input may be set to correspond to start an initial change of the definition of the locking image 21. The initial portion may be set as a twenty (20) percentage of the entire touch input. However, the present general inventive concept is not limited thereto. The initial portion may be greater than zero. It is possible that the initial portion may be a half of the entire user's touch input. The portion of the user's touch input may be preset as a predetermined ratio with respect to the entire portion of the user's touch input.

The computing device 1 may store the unlocking condition in a memory therein to corresponding to the entire portion of the user's touch input. The computing device 1 may compare the unlocking condition with the portion of the user's touch input. When the portion is increased, a portion of the unlocking condition to match the user's touch input is also increased. When the matched portion is increased, the level of the definition of the locking image 21 is changed as described above. When the entire portion of the user touch input matches the entire portion of the unlocking condition, the controller 13 unlocks the computing device 1.

When the user continuously inputs the remaining portion of the user's touch input, it is possible that any portion of the remaining portion of the user's touch input does not match the corresponding portion of the unlocking condition. In this case, it is possible that the definition of the locking image 21 may not be changed or that the definition of the locking image 21 may be restored or changed to an original definition level of the locking mode.

The controller 13 may include an image processor 14, a definition calculator 15 and an input analyzer 16. The image processor 14 processes an image to display the processed image as the locking image 21 on the screen 2. The definition calculator 15 calculates a degree (or level) of definition such that the degree (or level) of definition of the locking image 21 is changed according to the user's touch input. The input analyzer 16 analyzes a user's touch input which is received by the touch input unit 12. The controller 13 may include a computer program, a non-volatile memory to store the computer program therein, a volatile memory to load at least a portion of the computer program, and a microprocessor to execute the loaded computer program to perform the function thereof. The computer program of the controller 13 may include a basic input output system (BIOS), operating system (OS), device driver, application program, etc.

Although FIG. 2 illustrates the touch input unit 12 to input a user's touch input to the computing deice 1, the present general inventive concept is not limited thereto. When the computing g device 1 has a frame to define the screen 2, the frame may have a detecting unit installed therein as a contactless input unit to detect a presence of an object disposed over the screen 2 or spaced apart from a surface of the screen 2 by a distance. In this case, the touch input unit 12 may be the contactless input unit to input a user input without contacting (touching) the display unit 11 as the user's touch input. It is possible that the contactless input unit detects a location or movement of a user finger moving over the locking image 21 with respect to the screen 2. The contactless input unit may be disposed around the screen to detect a motion over a surface of the locking image of the screen as the user input using a coordinate system.

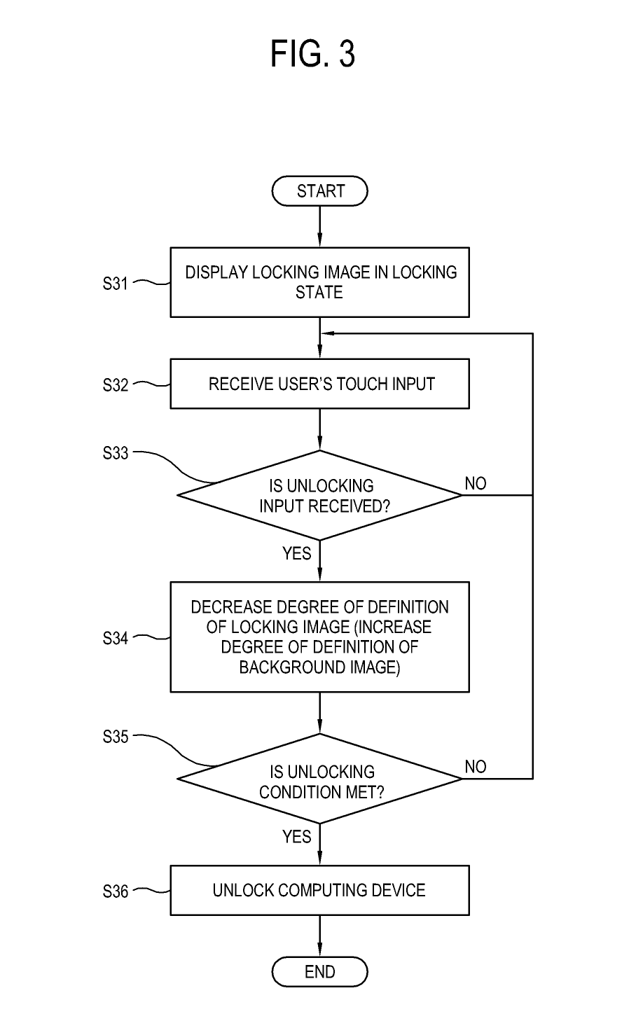

FIG. 3 is a flowchart illustrating a control method of the computing device 1 of FIG. 1. Referring to FIGS. 1, 2, and 3, the computing device 1 displays a locking image in a locking state (locking mode) at operation S31. FIG. 4 illustrates a screen when the computing device 1 is locked according to an exemplary embodiment of the present general inventive concept. As illustrated therein, a locking image 42 is displayed on a screen 41 in the locking state. It is possible that the screen 41 can include two or more locking images 42 for one or more users or one or more different function usages thereof. The two or more locking images 42 may be same. However, it is possible that the two or more locking images 42 may be different from each other. The locking image is not limited thereto in shape, size or content. The locking image 42 may include a content which shows that the computing device 1 is currently locked (e.g., a lock shape). According to an exemplary embodiment, the computing device 1 may further display a background image 43 while it is locked, as illustrated in FIG. 4. The background image 43 may be displayed to overlap the locking image 42. The locking image 42 may be disposed on a portion of the background image 43. It is possible that the locking image 42 may be superimposed with the background image 43. The background image 43 may be an initial image shown on the screen 41 when the computing device 1 is unlocked. The locking image 42 and the background image may be initial images simultaneously displayed on the screen 41. It is possible that the locking image 42 is displayed a predetermined time after the background image is displayed.

The locking image 42 has a predetermined degree (level) of definition. The degree of definition according to the present exemplary embodiment includes a degree of transparency. For example, while the computing device 1 is locked, the locking image 42 may be opaque such that a corresponding portion of the background image 43 is not visible or is hidden by the locking image 42. The background image 43 may have a lower degree of definition than the degree of the definition of the locking image 42. That is, the locking image 42 is clearly shown, compared to the background image 43. The background image 43 is less clear than the locking image 42.

Referring back to FIG. 3, at operation S32, the computing device 1 receives a user's touch input. A user may input a command by touching the screen to unlock the computing device 1. At operation S33, the computing device 1 determines whether the received user's touch input is an unlocking input. If it is determined that the user's touch input is not an unlocking input (No at operation S33), the computing device 1 ignores the received touch input and continues to receive a user's touch input at operation S32. The unlocking input may include a contact point sliding in a predetermined direction while a user's finger is in contact with the screen 41. For example, as illustrated in FIG. 4, the unlocking input may include sliding a portion of the user's finger in an upper direction 44 of the screen 41. According to an exemplary embodiment, the computing device 1 may further display an unlocking image (not illustrated) such as a particular shape, pattern, or visual effect, on the touched area of the screen 41.

When the contact point of the screen 41 moves, the computing device 1 may display an image to represent a movement of the contact point on the screen 1. The unlock condition may include an initial position, an end position, and one or more intermediate positions between the initial position and the end position, and the user's touch input may include an initial point, an end point, and one or more intermediate points which correspond to the positions of the unlocking condition. The contact points may be the user's touch input when matching the unlocking condition to unlock the computing device 1. The points may be continuously connected. It is possible that the positions may be disconnected at least once. It is also possible that the positions may be partially continuously connected and partially disconnected. It is also possible that the movement of the contact point may be a straight line, a curved line, or a diagram, for example, a triangular or rectangular shape.

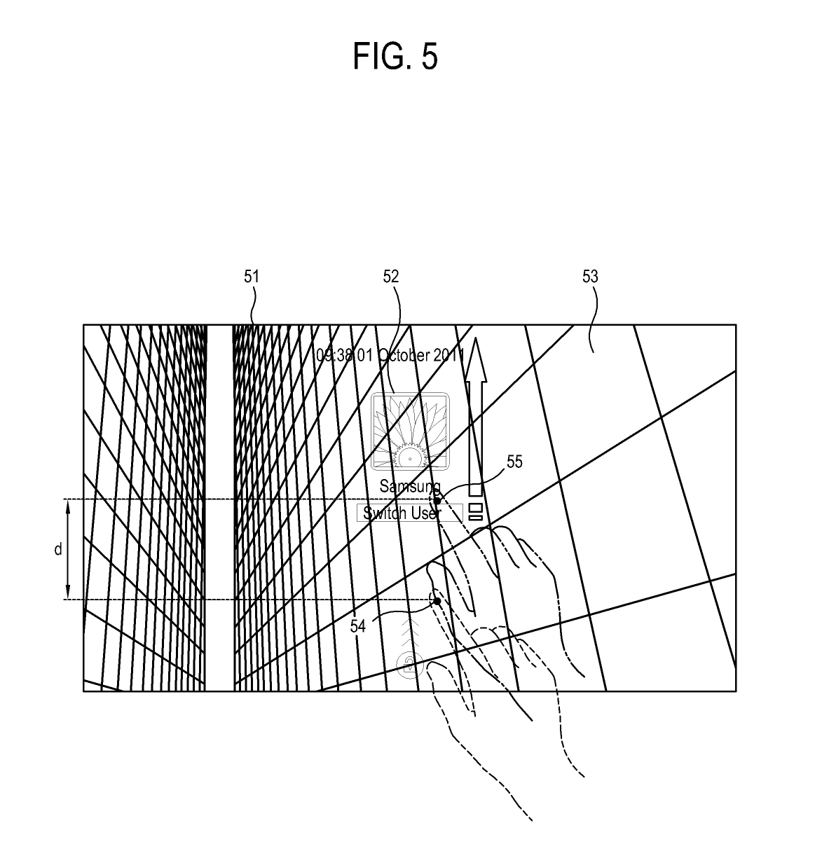

If it is determined that the touch input is an unlocking input (Yes at operation S33), the computing device 1 decreases the degree of definition of the locking image 42 at operation S34. FIG. 5 illustrates a screen 51 on which the unlocking input is received. If a user's touch input is slid from a lower location 54 of the screen 51 to an upper location 55, the computing device 1 determines that the touch input is an unlocking input. Then, the computing device 1 decreases the degree of definition of the locking image 52 when the unlocking input is received. The locking image 52 which is shown upon the input of the unlocking input is less clear than that in the prior locking state (refer to 42 in FIG. 4). According to an exemplary embodiment, the computing device 1 may increase the degree of definition of the background image 53 when the unlocking input is received. Accordingly, upon the unlocking input, the background image 53 is clearer than in the prior locking state (refer to 43 in FIG. 4). As a user views that the locking image 52 is gradually opaque according to a user's touch input and intuitively knows that the computing device 1 is in an unlocking process or an unlocked state (mode), user's convenience improves. Further, a user views that the background image 53 is clearer according to a user's touch input and intuitively knows that the computing device 1 is unlocked, and user's convenience improves further.

Referring to FIGS. 1-5, the display unit having 11 having the screen 21, 41, and 51 may have a structure or circuit to enable a user to input the user's touch input throughout an entire area of the touch panel such that a touch position of the lower location 54 and a touch position of the upper location 55 can be located within the screen 21, 41 and 51, respectively.

The display having 11 having the screen 21, 41, and 51 may not limit a user to input the user's touch input within a box or frame image like as a password input window or a switch user window illustrated in FIGS. 1, 4, and 5.

The display having the screen 21, 41, and 51 may have a structure or circuit to enable a user to set the unlocking condition throughout an entire area of the touch panel in the unlocking state such that a touch input between first and second positions inputted by a user in a unlocking state screen 22 with respect to the screen 21, 41, and 51 can be set as the unlocking condition as illustrated in FIGS. 7E and 7F.

Referring to FIG. 3, at operation S35, the computing device 1 determines whether a user's unlocking input meets the unlocking condition. If the user's unlocking input does not meet the unlocking condition (No at operation S35), the computing device 1 performs the operations S32 to S34 again. If it is determined that the user's unlocking input meets the unlocking condition (Yes at operation S35), the computing device 1 is unlocked. If the computing device 1 is unlocked, the computing device 1 may, e.g., remove the locking image 52 and clearly display the background image 53. A user may freely use functions of the computing device 1 by a user input when the computing device 1 is unlocked.

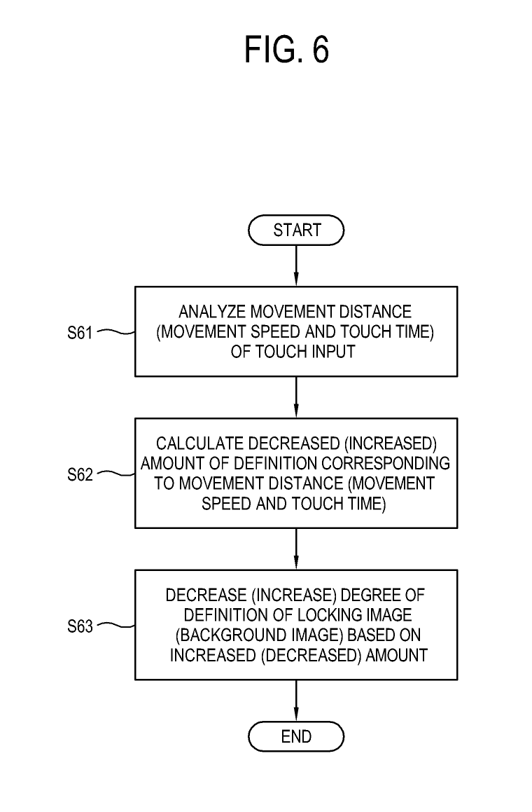

According to an exemplary embodiment, the computing device 1 may increase or decrease the degree of definition of the locking image and/or background image corresponding to a degree of movement of the user's unlocking input. FIG. 6 is a control flowchart illustrating a control method of the computing device 1 of FIG. 1. According to the present exemplary embodiment, the user's unlocking input is received while the computing device 1 is locked. At operation S61, the computing device 1 analyzes a movement distance of the user's touch input which is an unlocking input. For example, as illustrated in FIG. 5, the computing device 1 determines that the unlocking input has been moved by a distance “d” from the lower location 54 of the screen 51 to the upper location 55. At operation S62, the computing device 1 calculates the decreased amount of definition corresponding to the movement distance “d” of the unlocking input. For example, if the movement distance “d” of the unlocking input becomes longer, the decreased amount of the definition may become greater. The decreased amount of the definition may become greater than original definition. At operation S63, the computing device 1 calculates the degree of the definition of the locking image 52 based on the calculated decreased amount. Accordingly, as the unlocking input is performed, the locking image 52 becomes gradually opaque.

According to an exemplary embodiment, the computing device 1 may increase the degree of the definition of the background image 53 corresponding to the movement distance of the unlocking input. As the unlocking input is performed, the background image 53 becomes gradually clear.

According to exemplary embodiment, the computing device 1 may decrease or increase the degree of the definition of the locking image and/or background image corresponding to a movement speed of the unlocking input. For example, if the movement speed of the unlocking input is fast, that is, the contact point moves at the movement speed, the decreased amount of definition of the locking image 52 and the increased amount of definition of the background image 53 may become greater.

According to exemplary embodiment, the computing device 1 may decrease or increase the degree of the definition of the locking image and/or background image corresponding to a touch time of the unlocking input. This may apply to the case where the unlocking condition includes a touch input that is continued as long as a threshold time in a predetermined location of a screen. For example, if the continued time for the unlocking input is longer, the decreased amount of definition of the locking image 52 and the increased amount of definition of the background image 53 may become greater.

As described above, a computing device and a control method thereof according to the present invention enables a user to more intuitively unlock the computing device.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A computing device comprising:
a display unit to display a screen;
a touch input unit to receive a user's touch input on the display unit; and
a controller to display a locking image on the screen with a predetermined degree of definition when the computing device is locked, to decrease the degree of definition of the locking image if the user's touch input is determined to be an unlocking input, and to unlock the computing device if the unlocking input meets an unlocking condition.

2. The computing device according to claim 1, wherein the controller decreases the degree of definition of the locking image according to at least one of a movement distance, a movement speed and a touch time of the unlocking input.

3. The computing device according to claim 1, wherein the controller displays a background image with a lower degree of definition than the degree of definition of the locking image in the screen with the locking image when the computing device is locked, and increases the degree of definition of the background image if the user's touch input is determined to be the unlocking input.

4. The computing device according to claim 3, wherein the controller increases the degree of definition of the background image according to at least one of a movement distance, a movement speed and touch time of the unlocking input.

5. The computing device according to claim 1, wherein the controller displays an unlocking image on the screen corresponding to the unlocking input.

6. A control method of a computing device, the control method comprising:
displaying a locking image with a predetermined degree of definition on a screen of a display unit when the computing device is locked;
receiving a user's touch input on the display unit;
decreasing the degree of definition of the locking image when the user's touch input is determined to be the unlocking input; and
unlocking the computing device when the unlocking input meets an unlocking condition.

7. The control method according to claim 6, wherein the decreasing the degree of definition comprises decreasing the degree of definition of the locking image according to at least one of a movement distance, a movement speed and touch time of the unlocking input.

8. The control method according to claim 6, further comprising:
displaying a background image with a lower degree of definition than the degree of definition of the locking image in the screen with the locking image when the computing device is locked; and
increasing the degree of definition of the background image when the user's touch input is determined to be the unlocking input.

9. The control method according to claim 8, wherein the increasing the degree of definition comprises increasing the degree of definition of the background image according to at least one of a movement distance, a movement speed and touch time of the unlocking input.

10. The control method according to claim 6, further comprising:
displaying an unlocking image on the screen corresponding to the unlocking input.

11. A non-transitory computer-readable medium to contain computer-readable codes as a program to execute a control method of a computing device, the control method comprising:
displaying a locking image with a predetermined degree of definition on a screen of a display unit when the computing device is locked;
receiving a user's touch input on the display unit;
decreasing the degree of definition of the locking image when the user's touch input is determined to be the unlocking input; and
unlocking the computing device when the unlocking input meets an unlocking condition.

12. A computing device comprising:
a display unit having a screen with a locking image in a locking state;
an input unit to receive a user input through the display unit; and
a controller to control a characteristic of the locking image according to the user input to correspond to an unlocking condition until the locking state is changed to an unlocking state.

13. The computing device of claim 12, wherein the characteristic of the locking image comprises a definition of the locking image.

14. The computing device of claim 12, wherein the user input comprises a plurality of points disposed in the screen.

15. The computing device of claim 12, wherein the user input comprises a line connecting a first point to a second point within the screen.

16. The computing device of claim 12, wherein the user input comprises a line disposed within the screen.

17. The computing device of claim 12, wherein the user input comprises at least one disconnected portion.

18. The computing device of claim 12, wherein the controller controls the characteristic of the locking image before the computer device is changed from the locking state to the unlocking state.

19. The computing device of claim 12, wherein the controller controls the characteristic of the locking image according to an identical ratio between the user input and the unlocking condition.

20. The computing device of claim 12, wherein:
the characteristic of the locking image comprises a definition of the locking image; and
the controller controls the definition of the locking image according to a ratio of the user input with the unlocking condition.

21. The computing device of claim 12, wherein:
the characteristic of the locking image comprises a definition of the locking image;
the definition of the locking image comprises a plurality of sub-definitions; and
the controller controls the display unit to change the definition of the locking image between the sub-definitions.

22. The computing device of claim 12, wherein:
the locking image comprises a plurality of images displayed in the screen in a locking state; and
the controller controls characteristics of the images according to the user input.

23. The computing device of claim 12, wherein:
the controller compares at least a portion of the user input to the unlocking condition; and
the controller changes the characteristic of the locking image according to the comparison result until an entire portion of the user input corresponds to the unlocking condition.

24. The computing device of claim 12, wherein:
the controller starts a comparison operation when at least a portion of the user input is input through the display unit; and
the controller controls the characteristic of the locking image until the portion of the user input is increased to an entire portion of the user input corresponding to the unlocking condition.

25. The computing device of claim 12, wherein:
the controller controls the display unit to display a change of the characteristic of the locking image when a portion of the user input correspond to a portion of the unlocking condition; and
the controller stops a change of the characteristic of the locking image when at least a portion of the user input does not correspond to the unlocking condition.

26. The computing device of claim 12, wherein the controller performs a user change from a first user to a second user according to the user input corresponding to the unlocking condition.

27. The computing device of claim 12, wherein the display unit displays the locking image within a limited portion of the screen, and receives the user input within an unlimited portion of the screen in the locking state.

28. The computing device of claim 12, wherein the display unit receives the user input without an additional image displayed on the screen to correspond to the user input.
